(19) United States
(12) Patent Application Publication
(10) Pub. No.: US 2014/0293849 A1
(43) Pub. Date: Oct. 2, 2014

(54) POWERING A NETWORK DEVICE WITH CONVERTED ELECTRICAL POWER

(71) Applicant: HEWLETT-PACKARD DEVELOPMENT COMPANY, L.P., Houston, TX (US)

(72) Inventor: Andres Jose Odio Vivi, Heredia (CR)

(73) Assignee: Hewlett-Packard Development Company, L.P., Houston, TX (US)

(21) Appl. No.: 13/853,522

(22) Filed: Mar. 29, 2013

(51) Int. Cl. H04W 52/02; H02J 1/10

(52) U.S. Cl. CPC H04W 52/0206; H02J 1/10
USPC 370/311; 307/72; 307/25

(57) ABSTRACT

Examples disclose a networking device comprising a thermopile to convert a temperature difference between a heat surface and an ambient surface into electrical power. Additionally, the examples disclose a power management module to power the networking device with the converted electrical power.

### BACKGROUND

Networking devices receive and/or generate data within a networking system. These network devices may waste much energy and may be inefficient as much power is lost in the form of heat energy,

### BRIEF DESCRIPTION OF THE DRAWINGS

In the accompanying drawings, like numerals refer to like components or blocks. The following detailed description references the drawings, wherein:

FIG. 1 is a block diagram of an example networking device including a thermopile to obtain a temperature difference, between a heat surface and an ambient surface, and convert the temperature difference to electrical power for collection by a power management module;

FIG. 2A is a block diagram of an example thermoelectric generator including a thermopile and multiple thermocouples to obtain a temperature difference between surfaces to produce an electrical power output;

FIG. 2B is a block diagram of an example cross-section of a thermoelectric generator including a thermopile between a heat surface, ambient surface, a heat spreader, heat sink, and thermal interface material;

FIG. 3 is a flowchart of an example method to convert a temperature difference into electrical power and to power a networking device with the converted electrical power; and

FIG. 4 is a flowchart of an example method to convert a temperature difference into electrical power, power an internal component of a networking device, provide power to the internal component until the converted electrical power reaches a threshold, and dissipate heat energy from the temperature difference not converted into electrical power.

### DETAILED DESCRIPTION

Networking devices emit much heat energy from internal components. Thermoelectric generators convert the heat energy into electrical power; however, these generators are focused on larger scale applications. Other thermoelectric generators are focused on preventing a central processing until within a computing device from overheating. This may be inefficient as internal components within the networking device, such as a radio component may emit a greater magnitude of heat,

To address these issues, examples disclosed herein provide a networking device comprising a thermopile to convert a temperature difference between a heat surface and an ambient surface into electrical power. The thermopile is included as part of a thermoelectric generator. The networking device is further comprising a power management module to power the networking device with the converted electrical power. Converting the temperature difference within the networking device recycles the heat energy from an internal component that emits much heat energy, such as a radio and/or power amplifier. Recycling the heat energy into electrical power reduces the overall power consumption of the networking device.

In another example disclosed herein provides the networking device further comprising a heat sink. The heat sink, connected to the thermopile, dissipates the excess heat energy not converted into electrical power by the thermoelectric generator. Dissipating the heat not converted into electrical power prevents overheating of other internal components within the networking device.

In summary, examples disclosed herein provide a networking device to reduce the overall power consumption by recycling heat energy into electrical power. Additionally, the examples disclosed herein prevent overheating of the networking device.

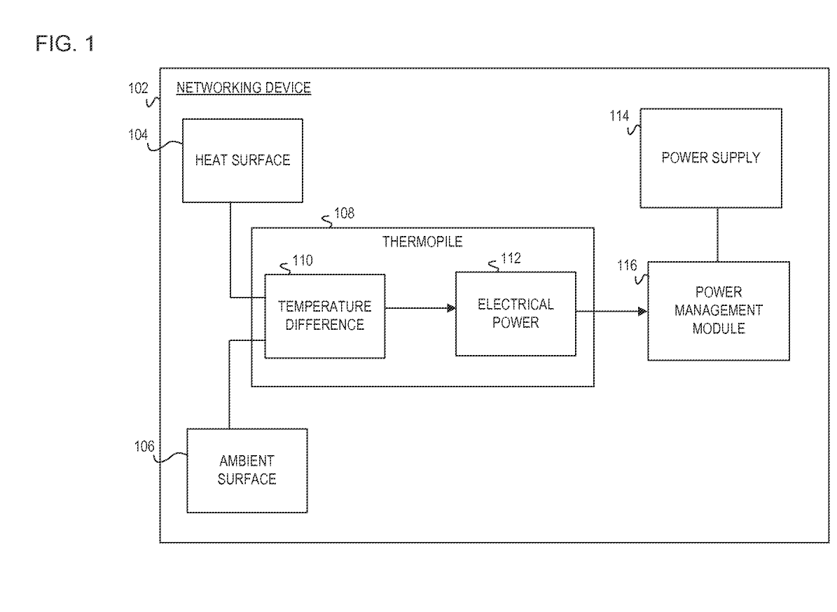

Referring now to the figures, FIG. 1 is a block diagram of an example networking device 102 including a thermopile 108 to obtain a temperature difference 110. The temperature difference 110 is the difference in heat energy between a heat surface 104 and an ambient surface 106. The thermopile 108 obtains the temperature difference 110 to convert into an electrical power 112 as indicated by the arrow in FIG. 1. The converted electrical power 112 is collected by a power management module 116 for use by a component internal to the networking device 102. The power management module 116 collects the converted electrical power 112 to supply to the internal component within the networking device 102. In one example, a power supply 114 is connected to the power management module 114 to provide power in addition to the converted electrical power 112 to power the networking device 102 and/or internal component (not illustrated),

The networking device 102 is a computing device which connects to a networking system to facilitate the use of exchanging data in the networking system. As such, the networking system may include a local area network, wide area network, wired network, and/or wireless network. In another example, the networking device 102 is a wireless access point device to enable wireless devices to connect to a wired network to exchange data wirelessly over the networking system. Examples of the networking device 102 include a surveillance camera, wireless access point, gateway, router, mobile phone, or other type of computing device within a network.

The heat surface 104 is a surface of an electrical component internal to the networking device 102 that produces heat energy. The electrical components may emit more heat than other components within the networking device 102, thus emitting a greater magnitude of heat or higher temperature. The thermopile 108 is installed within the networking device 102 such that it is connected to the heat surface 104 and the ambient surface 106. The heat surface 104 may include a surface to a component associated with the networking device 102. This component may heat up when in operation, thus producing or emitting a heat energy that is used to obtain the temperature difference 110. The temperature difference 110 is used by thermopile 108 to generate the electrical power 112, In one example, the heat surface 104 includes a surface of a radio component within the networking device 102. In a further example, the networking device 102 utilizes a heat spreader to harvest the heat energy from the heat surface 104 of a component for measurement at the thermopile 108. Examples of the heat surface 104 include a radio, amplifier, sensor, switch, or other type of electrical component internal to the networking device 102 that emits heat energy.

The ambient surface 106 is a surface associated with the networking device 102 that provides a cooler temperature compared to the heat surface 104 so the thermopile 108 may obtain the temperature difference 110. In one example, the ambient surface 106 includes a casing to the networking device 102. In this example, the thermopile 108 connects to the casing of the networking device 102 to obtain a known and/or cooler temperature compared to the heat surface 104. In another example, the ambient surface 106 may be exposed to outside of the networking device 102. In a further example, the ambient surface 106 includes a heat sink or other type of device to provide a cooler temperature compared to the heat surface 104.

The thermopile 108 is considered as part of a thermoelectric generator that converts thermal energy into electrical energy. In one example, the thermopile 108 includes multiple thermocouples connected in series to increase the amount of electrical power 112 provided at the output of the thermopile 108. Each thermocouple includes two dissimilar conductors in contact that produce an electrical power (e.g., voltage) when subjected to a temperature gradient. The thermopile 108 includes two parallel ceramic and/or metallic plates that sandwich the multiple thermocouples. One of the plates absorbs the heats and transfers to the cooler plate. These examples are explained in detail in later figures.

The temperature difference 110, between the heat surface 104 and the ambient surface 106, is converted by the thermopile 108 into the electrical power 112. The temperature difference 110 is a magnitude of heat energy between the surfaces 104 and 106. The thermopile 108 includes junctions connecting the thermopile 108 to each of the surface 104 and 106 using conducting material to obtain the temperature difference 110. Obtaining the temperature difference 110, the thermopile 108 may recycle heat energy emitted from the internal component into the converted electrical power 1112 to decrease overall power consumption of the networking device 102 by the power supply 114.

The converted electrical power 112 is collected by the power management module 116 for use by the networking device 102. Converting the electrical power 112 from the temperature difference 110 enables the networking device 102 to recycle heat energy to electricity for powering components within the networking device 102. Examples of the converted electrical power 112 may include single dement or combination of voltage, current, watts, or other type of electrical power for use by an internal component and/or the networking device 102.

The power management module 116 processes the converted electrical power 112 for distributing the power 112 within the networking device 102. The power management module 116 harvests, stores, and/or collects the converted electrical power 112 for distribution. For example, the power management module 116 may include a capacitor to store the converted electrical power 112 for distributing for use by the networking device 102. In one example, the power management module 116 may include components to filter the converted electrical power 112 for distribution among the internal component and/or networking device 102. As such, examples of the power management module 116 include a converter, rectifier, power storage, power factor correcting module, circuit logic, amplifier, or other type of power management device to process the converted electrical power 112 for distribution to the internal component and/or networking device 102. In another example, the converted electrical power 112 may be combined with the power supply 114 to power the networking device 102 and its components. In a further example, the power management module 116 supplies power to an internal component, except a processor, within the networking device 102.

The power supply 114 provides the primary source of power to the networking device 102. The converted electrical power 112 supplies power in addition to the power supply 114 for the internal component(s) and the networking device 102. The primary power supplied by the power supply 114 provides the main source of power for the networking device 102, while the converted electrical power 112 supplements this power supply 114 to decrease the overall amount of power consumed from the power supply 114, In one example, the power supply 114 provides the power to the networking device 102 until the converted electrical power 112 reaches a particular magnitude of power (i.e., threshold). In this example, the power supply 114 reduces the amount of power supplied to the networking device 102 as the converted electrical power 112 supplies the additional power for use by the networking device 102. Examples of the power supply 114 include energy storage, battery, fuel cell, generator, alternator, solar power supply, electromechanical supply, converter, rectifier, or other type of power supply capable of supplying the primary power to the networking device 102.

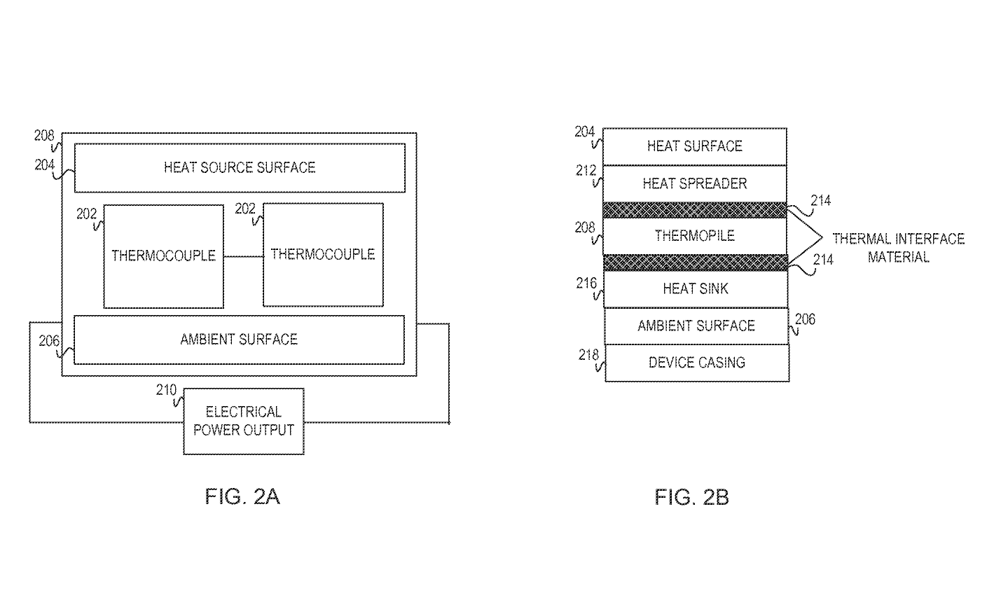

FIG. 2A is a block diagram of an example thermoelectric generator as installed in a networking device. The thermoelectric generator includes a thermopile 208 and multiple thermocouples 202 sandwiched between an ambient surface 206 and a heat source surface 204. The thermopile 208 produces an electrical power output 210 through sandwiching the thermocouples 202 between the surfaces 204 and 206. The surfaces 204 and 206 are plates of ceramic and/or metallic material to absorb heat and/or cooling temperatures for the thermopile 208 to obtain a temperature difference. The thermopile 208 is installed in a networking device to reduce the amount of power consumed from a power supply by using the device's heat energy to supplement the power.

The thermocouples 202 positioned between the surfaces 204 and 206, convert the temperature difference between the surfaces 204 and 206 to the electrical power output 210. Each of the thermocouples 202 include at least two conductors. Each conductor is connected to a junction of one of the surfaces 204 or 206 to obtain the temperature difference. The thermocouples 202 are connected in series with each other to form a closed loop circuit to produce the electrical power output 210. For example, each conductor may be connected to both the ambient surface 206 and the heat source surface 204 and since each conductor is composed of different material, the voltage produced across each conductor is different. In this example, each conductor responds differently to the temperature difference, creating a current loop and electric field, thus producing the electrical power output 210. For example, both conductors may be exposed to a particular temperature difference, such as 60 degrees Celsius. The voltage produced across one of the conductors may include one volt, while the voltage across the other conductor may include 0.4 volts. In this example, the electrical power output 210 voltage produced by one of the thermocouples 202 would the difference in voltage between both conductors which may result in around 6 millivolts, while the multiple thermocouples 202 connected in series within a thermopile 208 may result in around 300 millivolts.

FIG. 2B is a block diagram of an example cross-section of a thermoelectric generator including a thermopile 208 as installed in a networking device. A heat surface 204 and an ambient surface 206 are considered a hot side and a cold side, respectively, of the thermopile 208. The ambient surface 206 is connected to the network device casing 218. The heat surface 204 is connected to a heat spreader 212 to transfer heat to a thermopile 208. The thermopile 208 is positioned in between thermal interface material 214 to provide thermal conductivity from the heat spreader 212. In another example, the thermal interface material 214 may be positioned between an electrical component corresponding to the heat surface 204 and the heat spreader 212,

The heat surface 204 is connected to an electrical component internal to the networking device that produces heat energy which is transferred by the heat spreader 212 to the thermopile 208. The heat spreader 212 is connected to the thermopile 214 through the thermal interface material 214. Although FIG. 2B illustrates the heat spreader 212 connected to a single heat source component, examples should not he limited as this was done for illustration purposes and not for limiting examples. For example, the heat spreader 212 may be connected to multiple heat source components to transfer the heat energy from these components to the thermopile 214 to obtain the temperature difference. Additionally, although FIG. 2B illustrates the heat spreader 212 as internal to the thermoelectric generator, examples should not be limited to this illustration as the heat spreader 212 may be external to the thermoelectric generator. For example, the heat spreader may be external to the thermopile 208 to transfer heat from multiple heat components to the thermopile 208.

The thermal interface material 214, located on either side of the thermopile 208, may provide thermal conductivity from the heat spreader 212 to the thermopile 208. In another example, the thermal interface material 2114 may provide thermal insulation and/or thermal conductivity from the heat sink 216 to the thermopile 208. For example, the thermal interface material 214 may protect the thermopile 208 from overheating with excessive heat. In a further example, the thermal interface material 2.14 may enable the heat spreader 2.12. to transfer heat to the thermopile, by providing thermal conductivity. Although FIG, 2B illustrates the thermal interface material 214 between the thermopile 208, examples should not be limited to this illustration as the thermal interface material 214 may be on the outer portion of thermoelectric generator. For example, the thermoelectric material 214 may be on the outer surface of the heat surface 204 (e.g., the surface opposite to the heat spreader) and between the ambient surface 206 and the device casing 218. The heat sink 216, connected to the thermopile 208 through the thermal interface material 214, dissipates heat energy which may not be converted into the electrical power. The heat sink 216 is a heat exchanger component to cool the thermoelectric generator and/or networking device by dissipating excessive heat unused by the thermopile 208. The ambient surface 206, connected to the networking device casing 218 creates a cooler temperature for comparison against the heat surface 204. In another example, the device casing 218 may serve as a grounding path for the thermoelectric generator.

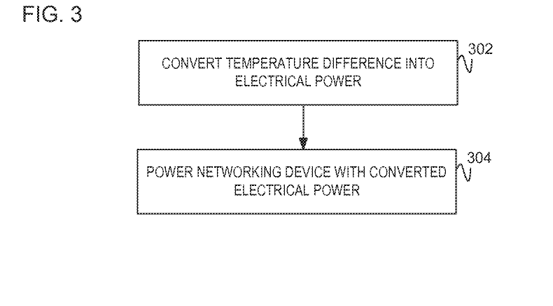

FIG. 3 is a flowchart of an example method to convert a temperature difference, between a heat surface and an ambient surface, into electrical power. Further, the method powers a networking device with the converted electrical power. In discussing FIG. 3, references may be made to the components in FIGS. 1-2B to provide contextual examples. Further, although FIG. 3 is described as implemented by thermopile 108 within the networking device 102 as in FIG. 1, it may be executed on other suitable components. For example, FIG. 3 may be implemented in the form of executable instructions on a machine-readable storage medium within the networking device 102. In a further example, FIG. 3 may be executed on a processor within the networking device 102.

At operation 302, the thermopile associated with the networking device converts the temperature difference into electrical power. The thermopile includes multiple thermocouples connected in series to increase the electrical power since only a small amount of voltage is produced by each thermocouple. As such, the multiple thermocouples to form the thermopile increase the efficiency to produce the electrical power. The thermopile converts the heat energy (i.e., temperature difference) into electrical power using a thermoelectric generation effect (e.g., Seebeck effect). The Seebeck effect is used in each thermocouple to obtain a voltage as a result of the temperature difference. in operation 302, a temperature at the ambient surface may be cooler than the temperature at the heat surface, resulting in the temperature difference. The thermopile is a closed loop formed by multiple heat conductors (e.g., two conductors) connected at multiple junctions (e.g., two junctions), with the temperature difference between these junctions. At operation 302, the temperature difference is between the heat surface component and the ambient surface component, thus the thermopile is a closed circuit connected at each of these surfaces to obtain the temperature difference. For example, each conductor may include an ambient surface and a heat surface, so they each respond differently to the temperature difference, creating a current loop and electric field, thus producing the electrical power. The thermopile receives two different temperatures to obtain the temperature difference. In this example, the networking device may include temperature sensors located in proximity to the heat surface and the ambient surface. In a further example, a heat spreader may transfer heat energy from the heat surface component to the networking device to determine the temperature difference. Connecting one side of the thermopile to a heat source component and another side to the networking device casing generates electrical power. The electrical power may be used by the networking device and/or internal component.

At operation 304, the thermopile may transfer the electrical power produced at operation 302 to the internal component to power the networking device. Operation 304 harvests the heat energy produced at operation 302 and converts the heat energy into electrical power. The electrical power may be stored and/or collected until transferring the power to the internal component of the networking device. Operation 304 recycles the heat energy produced from internal component to generate an electrical output to power the networking device. Recycling the heat energy and converting to electrical power reduces the overall power consumption by the networking device. In a further example, the internal component powered by the converted electrical power may include a non-essential component to the operational function of the networking device. The non-essential component is considered an extraneous component which is an internal component to the networking device that may suffer damage and/or fail without the networking device failing. In this example, this extraneous component is considered non-essential in the primary function of the networking device. For example, such components may include a fan, alarm, sensor, radio, amplifier, light emitting diode, etc. The essential component is considered an internal component which may be imperative to the primary function of the networking device. In this regard, if the essential component suffers a failure, the networking device may fait As such, examples of the essential components include a controller, microprocessor, memory, or other type of component fur the primary function of the networking device. In another example, a power supply associated with the networking device powers the extraneous component until the converted electrical power reaches a threshold to power the extraneous component.

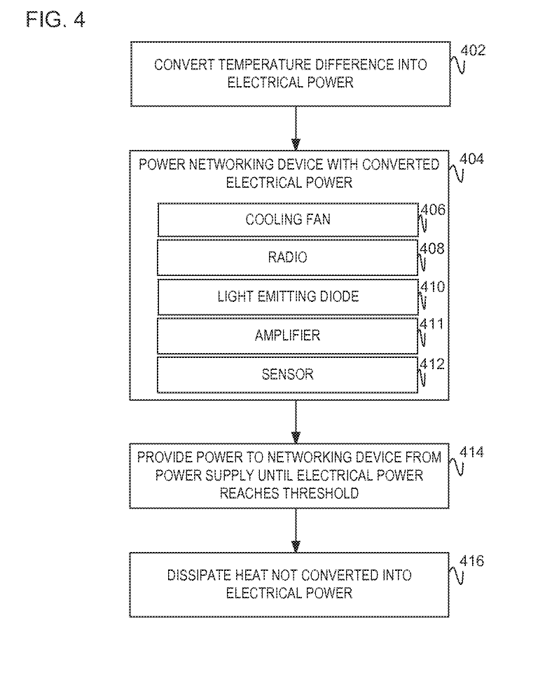

FIG. 4 is a flowchart of an example method to convert a temperature difference into electrical power and to power an internal component of a networking device. Further, the method provides power to the internal component until the converted electrical power reaches a threshold and dissipates heat energy from the temperature difference not converted into electrical power. In discussing FIG, 4, references may be made to the components in FIGS. 1-2B to provide contextual examples. Further, although FIG. 4 is described as implemented by a thermopile 108 within a networking device 102 as in FIG. 1, it may be executed on other suitable components. For example, FIG. 4 may be implemented in the form of executable instructions on a machine-readable storage medium within the networking device 102. In a further example, FIG. 4 may be executed on a processor within the networking device 102.

At operation 402, the thermopile converts a temperature difference, between an ambient surface and a heat surface, into electrical power. The ambient surface serves as a cooler temperature for a comparison against the heat surface to obtain the temperature difference. The temperature difference, also considered the heat energy, is converted into electrical power for use by an internal component to the networking device. Operation 402 may be similar in functionality to operation 302 as in FIG. 3.

At operation 404, the converted electrical power at operation 402 may be used to power the internal component within the networking device. In one example, the converted electrical power may be provided to an internal component of the networking device. The internal component may include a cooling fan, radio, light emitting diode (LED), amplifier, and/or sensor as at operations 406-412. In a further example, the components as at operations 406-412 may be in a sleep mode until the converted electrical power reaches a particular threshold to power one of these components.

At operation 414, the power supply may provide power to the internal component within the networking device until the converted electrical power at operation 402 reaches a particular threshold. The particular threshold is the power utilized by the internal component for operation 402. The electrical power threshold corresponds to the temperature difference, so the greater the temperature difference, the greater the amount of converted electrical power, At operation 414, the power supply may provide power in addition to the converted electrical power at operation 402 to power the networking device.

At operation 416 the heat energy not converted into electrical power at operation 402 is dissipated or shunted through a heat sink. Operation 416 prevents overheating that may be caused be excess heat energy that is not converted into the electrical power.

In summary, examples disclosed herein provide a networking device to reduce the overall power consumption by recycling heat energy into electrical power. Additionally, the examples disclosed herein prevent overheating of the networking device.

I claim:

1. A networking device comprising:
a thermopile to convert a temperature difference between a heat surface and an ambient surface into electrical power; and
a power management module to power the networking device with the converted electrical power.

2. The networking device of claim 1 wherein the thermopile includes multiple thermocouples connected in series to convert the temperature difference into electrical power.

3. The networking device of claim 1 wherein the ambient surface includes a casing associated with the networking device and the heat surface includes a component positioned within the networking device, the component includes at least one of a radio and an amplifier.

4. The networking device of claim 1 wherein the networking device includes an access point device.

5. The networking device of claim 1 further comprising:
a heat sink, connected to the thermopile, to dissipate heat energy not converted into electrical power.

6. The networking device of claim 1 further comprising:
a power supply to power the networking device in addition to the converted electrical power.

7. The networking device of claim I further comprising:
a heat spreader, connected between the thermopile and the heat source, to transfer heat from multiple heat source components to the thermopile.

8. The networking device of claim 1 further comprising:
a thermal interface, connected between the thermopile and the ambient surface, to provide thermal conductivity.

9. A method, executable by a networking device, the method comprising:
converting a temperature difference, between an ambient source and a heat source, into electrical power for use by the networking device; and
powering the networking device with the converted electrical power.

10. The method of claim 9 further comprising:
dissipating heat energy not converted into the electrical power through a heat sink.

11. The method of claim 9 further comprising:
providing power to the networking device by a power supply in addition to the converted electrical power.

12. The method of claim 9 wherein powering the networking device with the converted electrical power includes providing power to one of the following associated with the networking device:
cooling fan, radio, light emitting diode, amplifier, and sensor.

13. A networking system comprising:
a heat spreader to transfer heat energy from a heat source component to a thermopile;
the thermopile to convert the heat energy between an ambient source and the heat source component into electrical power;
a power source to power a networking device until the converted electrical power reaches a threshold; and
a power management module to receive and convert the converted electrical power.

14. The networking system of claim 13 wherein the heat spreader transfers heat energy from multiple heat source components to the thermopile.

15. The networking system of claim 13 further comprising:
a module connected to the power management module to transmit power to components, non-essential to operation of the networking device, the components positioned within the networking system.
